(19) United States
(12) Patent Application Publication
(10) Pub. No.: US 2022/0353442 A1
(43) Pub. Date: Nov. 3, 2022

(54) TIME-OF-FLIGHT (TOF) CAMERA DEVICE

(71) Applicant: Samsung Electro-Mechanics Co., Ltd., Suwon-si (KR)

(72) Inventors: Dong Hoon LEE, Suwon-si (KR); Do Hwan KIM, Suwon-si (KR); Sang Hyun JI, Suwon-si (KR); Jung Hyun PARK, Suwon-si (KR); Byung Gi AN, Suwon-si (KR)

(73) Assignee: Samsung Electro-Mechanics Co., Ltd., Suwon-si (KR)

(21) Appl. No.: 17/679,535

(22) Filed: Feb. 24, 2022

(30) Foreign Application Priority Data
May 3, 2021 (KR) 10-2021-0057406

(51) Int. Cl. H04N 5/351; H04N 5/374; G01S 17/50; G01S 17/894; G01S 7/481

(52) U.S. Cl. CPC H04N 5/351; H04N 5/374; G01S 17/50; G01S 17/894; G01S 7/4814

(57) ABSTRACT

A time-of-flight (TOF) camera device including an optical transmitter configured to transmit light to a subject, an optical receiver configured to receive light reflected from the subject, and an actuator configured to adjust either one or both of an optical scanning direction and field of luminance (FOL) of the optical transmitter.

### CROSS-REFERENCE TO RELATED APPLICATIONS

This application claims the benefit under 35 USC 119(a) of Korean Patent Application No. 10-2021-0057406 filed on May 3, 2021, in the Korean Intellectual Property Office, the entire disclosure of which is incorporated herein by reference for all purposes.

### BACKGROUND

### 1. Field

This application relates to a time-of-flight (TOF) camera.

### 2. Description of Related Art

Recently, time-of-flight (TOF) modules capable of performing three-dimensional (3D) image sensing may support object recognition or a facial recognition function, and the TOF modules have been increasingly installed in the latest high-end smartphones. In addition to smartphones, interest in the TOF modules has increased in the fields of artificial reality (AR), virtual reality (VR), and gaming.

In addition, as 3D sensing is applied to artificial intelligence (AR)-based robotics, a new level of interaction systems with humans to increase understanding of a surrounding environment has been developed.

In general, TOF technology is a 3D sensing technology that recognizes a three-dimensional effect, spatial information, and movement of an object by calculating a distance based on a time during which light emitted toward a subject is reflected and returned.

A TOF camera to which this TOF technology is applied has a limited measurement distance due to an external environment (light) in terms of the nature of the technology, has a limited power that may be used in relation to eye safety because a transmitter uses a laser, does not have an adjustable optical scanning direction, and has a limitation in a measurement distance due to a degraded resolution when the measurement distance increases.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a time-of-flight (TOF) camera device includes an optical transmitter configured to transmit light to a subject; an optical receiver configured to receive light reflected from the subject; and an actuator configured to adjust either one or both of an optical scanning direction and a field of luminance (FOL) of the optical transmitter.

The actuator may include a first actuator configured to adjust an optical scanning direction of the optical transmitter, and the first actuator may include a first driving coil disposed in an external case and spaced apart from the optical transmitter, and configured to generate a magnetic force according to a first driving current; and a first magnet disposed in an internal case of the optical transmitter and facing the first driving coil, and configured to adjust the optical scanning direction of the optical transmitter according to the magnetic force generated by the first driving coil.

The first actuator may further include a guide ball configured to move according to a magnetic force between the first driving coil and the first magnet to adjust the optical scanning direction of the optical transmitter.

The optical transmitter may include a light source configured to generate light to be scanned to the subject; a transmit (TX) lens unit including a plurality of lenses configured to focus the light from the light source; and a diffraction optical element (DOE) lens unit configured to convert the focused light from the TX lens unit into DOE pattern light and scan the DOE pattern light to the subject.

The DOE lens unit may include a first DOE lens disposed to be perpendicular to an optical axis; and a second DOE lens disposed to be spaced apart from the first DOE lens by a predetermined distance and perpendicular to the optical axis, wherein one of the first DOE lens and the second DOE lens is configured to be movable to adjust the FOL of the optical transmitter.

The actuator may include a second actuator configured to adjust the FOL of the optical transmitter, and the second actuator may include a second driving coil disposed inside an internal case of the optical transmitter and spaced apart from the DOE lens unit, and configured to generate a magnetic force according to a second driving current; and a second magnet disposed in a case of the DOE lens unit and facing the second driving coil, and configured to adjust a position of the one of the first DOE lens and the second DOE lens that is configured to be movable according to the magnetic force generated by the second driving coil.

The optical transmitter may further include a liquid crystal lens unit disposed between the TX lens unit and the DOE lens unit, and configured to adjust the FOL of the optical transmitter in response to a voltage.

The optical receiver may include a receive (RX) lens unit configured to focus light incident on the RX lens unit from the subject; and an optical sensor configured to sense the focused light from the RX lens unit.

In another general aspect, a time-of-flight (TOF) camera device includes an optical transmitter configured to transmit light to a subject; an optical receiver configured to receive light reflected from the subject; an actuator configured to adjust either one or both of an optical scanning direction and a field of luminance (FOL) of the optical transmitter; and a driving circuit configured to adjust the optical transmitter by controlling the actuator based on a position of the subject.

The driving circuit may include a transmit (TX) direction controller configured to control the optical scanning direction of the optical transmitter.

The TX direction controller may include a first monitoring unit configured to select a measurement region and monitor a target position of the subject; a first controller configured to calculate a target movement distance and a target movement direction based on a current position of the subject and the target position of the subject; a first driving unit configured to generate a first driving current and output the generated first driving current to the actuator under control of the first controller; and a first sensing unit configured to sense the current position of the optical transmitter.

The driving circuit may further include a TX angle of view (FOL) controller configured to adjust the FOL of the optical transmitter.

The TX FOL controller may include a second monitoring unit configured to monitor a target angle of the subject using user selection of a measurement region or automatic selection of a measurement region; a second controller configured to calculate a target movement distance and a target movement direction based on a current FOL of the optical transmitter and the target angle of the subject; a second driving unit configured to generate a second driving current and output the generated second driving current to the actuator under control of the second controller; and a second sensing unit configured to sense the current FOL of the optical transmitter.

The actuator may include a first actuator configured to adjust the optical scanning direction of the optical transmitter, and the first actuator may include a first driving coil disposed in an external case and spaced apart from the optical transmitter, and configured to generate a magnetic force according to a first driving current; and a first magnet disposed in an internal case of the optical transmitter and facing the first driving coil, and configured to adjust the optical scanning direction of the optical transmitter according to the magnetic force generated by the first driving coil.

The first actuator may further include a guide ball configured to move according to a magnetic force between the first driving coil and the first magnet to adjust the optical scanning direction of the optical transmitter.

The optical transmitter may include a light source configured to generate light to be scanned to the subject; a transmit (TX) lens unit including a plurality of lenses configured to focus the light from the light source; and a diffraction optical element (DOE) lens unit configured to convert the focused light from the TX lens unit into DOE pattern light and scan the DOE pattern light to the subject.

The DOE lens unit may include a first DOE lens disposed to be perpendicular to an optical axis; and a second DOE lens disposed to be spaced apart from the DOE lens by a predetermined distance and perpendicular to the optical axis, wherein one of the first DOE lens and the second DOE lens is configured to be movable to adjust the FOL of the optical transmitter.

The actuator may further include a second actuator configured to adjust the FOL of the optical transmitter, and the second actuator may include a second driving coil disposed inside an internal case of the optical transmitter spaced apart from the DOE lens unit and configured to generate a magnetic force according to a second driving current; and a second magnet disposed in a case of the DOE lens unit, facing the second driving coil, and configured to adjust a position of the first DOE lens or the second DOE lens included in the DOE lens unit according to the magnetic force generated by the second driving coil.

The optical transmitter may further include a liquid crystal lens unit disposed between the TX lens unit and the DOE lens unit and configured to adjust the FOL of the optical transmitter in response to a voltage under control of the driving circuit.

The optical receiver may include: a receive (RX) lens unit configured to focus light incident on the RX lens unit from the subject; and an optical sensor configured to sense the focused light from the RX lens unit.

In another general aspect, a time-of-flight (TOF) camera device includes an optical transmitter configured to transmit light to a subject; an optical receiver configured to receive light reflected from the subject; and an actuator configured to adjust either one or both of a position of a measurement area and a resolution of the TOF camera.

The actuator may be further configured to adjust the position of the measurement area by adjusting an optical scanning direction of the optical transmitter.

The actuator may include a first actuator configured to adjust the optical scanning direction of the optical transmitter, and the first actuator may include a first driving coil disposed in an external case and spaced apart from the optical transmitter, and configured to generate a magnetic force according to a first driving current; and a first magnet disposed in an internal case of the optical transmitter and facing the first driving coil, and configured to adjust the optical scanning direction of the optical transmitter according to the magnetic force generated by the first driving coil.

The actuator may be further configured to adjust the resolution by adjusting a field of luminance (FOL) of the optical transmitter.

The optical transmitter may include a light source configured to generate light to be scanned to the subject; a transmit (TX) lens unit including a plurality of lenses configured to focus the light from the light source; and a diffraction optical element (DOE) lens unit configured to convert the focused light from the TX lens unit into DOE pattern light and scan the DOE pattern light to the subject.

The DOE lens unit may include a first DOE lens disposed to be perpendicular to an optical axis; and a second DOE lens disposed to be spaced apart from the first DOE lens by a predetermined distance and perpendicular to the optical axis, wherein one of the first DOE lens and the second DOE lens is configured to be movable to adjust the FOL of the optical transmitter.

The actuator may include a second actuator configured to adjust the FOL of the optical transmitter, and the second actuator may include a second driving coil disposed inside an internal case of the optical transmitter and spaced apart from the DOE lens unit, and configured to generate a magnetic force according to a second driving current; and a second magnet disposed in a case of the DOE lens unit and facing the second driving coil, and configured to adjust a position of the one of the first DOE lens and the second DOE lens that is configured to be movable according to the magnetic force generated by the second driving coil.

The optical transmitter may further include a liquid crystal lens unit disposed between the TX lens unit and the DOE lens unit, and configured to adjust the FOL of the optical transmitter in response to a voltage.

Other features and aspects will be apparent from the following detailed description, the drawings, and the claims.

### BRIEF DESCRIPTION OF DRAWINGS

FIG. 1 is a view of an example of a time-of-flight (TOF) camera device.

FIG. 2 is a view of another example of a TOF camera device.

FIG. 3 is a view of an example of the driving circuit of FIG. 2.

FIG. 4 is a view illustrating an operation of the driving circuit of FIG. 3.

FIG. 5 is a view of another example of the driving circuit of FIG. 3.

FIG. 6 is a view illustrating an operation of the driving circuit of FIG. 5.

FIG. 7 is a view of an example of an optical transmitter and an optical receiver.

FIG. 8 is a view of another example of an optical transmitter and an optical receiver.

FIG. 9 is a view illustrating an example of adjustment of an optical scanning direction of the optical transmitter of FIG. 7.

FIG. 10 is a view illustrating another example of adjustment of the optical scanning direction of the optical transmitter of FIG. 7.

FIG. 11 is a side view of another example of an optical transmitter and an optical receiver.

FIG. 12 is a front view of the optical transmitter and the optical receiver of FIG. 11.

FIG. 13 is a view illustrating an example of adjustment of a field of luminance (FOL) of the optical transmitter of FIG. 11.

FIG. 14 is a view illustrating another example of adjustment of the FOL of the optical transmitter of FIG. 11.

FIG. 15 is a view illustrating an example of adjustment of an optical scanning direction and an FOL of the optical transmitter of FIG. 11.

FIG. 16 a view illustrating another example of adjustment of the optical scanning direction and the FOL of the optical transmitter of FIG. 11.

FIG. 17 is a view of another example of an optical transmitter.

FIGS. 18A and 18B are views illustrating examples of an operation of a liquid crystal lens unit of the optical transmitter of FIG. 17.

FIGS. 19A and 19B are views illustrating examples of optical scanning according to whether or not a subject is tracked.

FIGS. 20A, 20B, and 20C are views illustrating examples of adjustment of an FOL using a diffraction optical element (DOE) lens.

FIGS. 21A and 21B are views illustrating examples of a change in a resolution according to adjustment of an FOL.

FIG. 22 is a view illustrating a measurement distance according to adjustment of an FOL.

FIG. 23 is a view illustrating an example of improvement of a resolution according to adjustment of an FOL and an optical scanning direction.

FIGS. 24A and 24B are views illustrating other examples of improvement of a resolution according to adjustment of an FOL and an optical scanning direction.

FIGS. 25A and 25B are views illustrating other examples of improvement of a resolution according to adjustment of an FOL.

FIGS. 26A and 26B are views illustrating other examples of improvement of a resolution according to adjustment of an FOL and an optical scanning direction.

FIG. 27 is a block diagram illustrating an example of the driving circuit of FIGS. 2, 3, 5, and 8.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Use herein of the word “may” in describing the various examples, e.g., as to what an example may include or implement, means that at least one example exists in which such a feature is included or implemented, but not all examples are limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure of this application. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Furthermore, although the examples described herein have a variety of configurations, other configurations are possible as will be apparent after an understanding of the disclosure of this application.

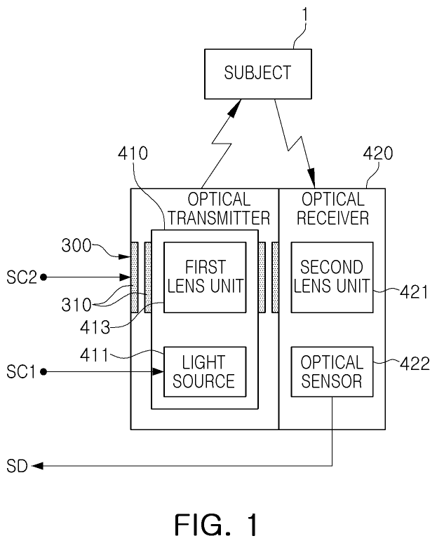

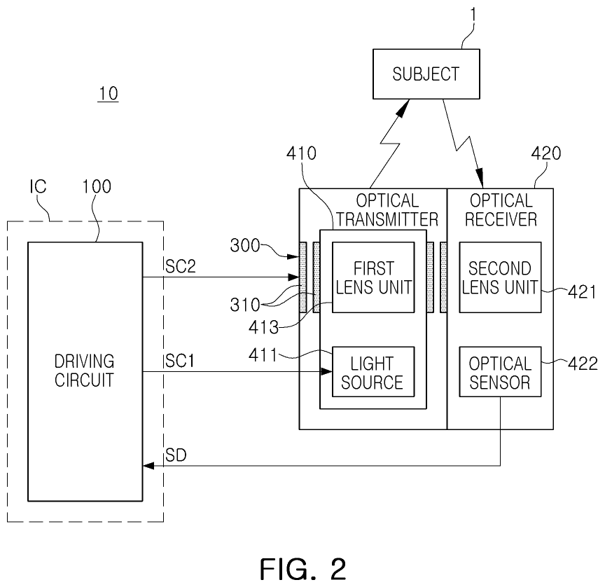

FIG. 1 is a view of an example of a time-of-flight (TOF) camera device, and FIG. 2 is a view of another example of a TOF camera device.

Referring to FIG. 1, a TOF camera device 10 may include an optical transmitter 410, an optical receiver 420, and an actuator 300.

Referring to FIG. 2, the TOF camera device 10 may include an optical transmitter 410, an optical receiver 420, an actuator 300, and a driving circuit 100.

Referring to FIGS. 1 and 2, the optical transmitter 410 may scan light to a subject 1. For example, the light scanned by the optical transmitter 410 may be from a laser, but is not limited thereto.

The optical receiver 420 may receive light reflected from the subject 1.

The actuator 300 may adjust either one or both of an optical scanning direction and an optical scan angle, i.e., a field of luminance (FOL), of the optical transmitter 410. In this application, the optical scan angle is referred to as the FOL.

In this application, examples in which light transmitted from the optical transmitter is from a laser are described for convenience of description, but the light is not limited thereto.

Referring to FIG. 2, the driving circuit 100 may control either one or both of the optical scanning direction and the FOL of the optical transmitter 410 by controlling the actuator 300 based on a position of the subject 1.

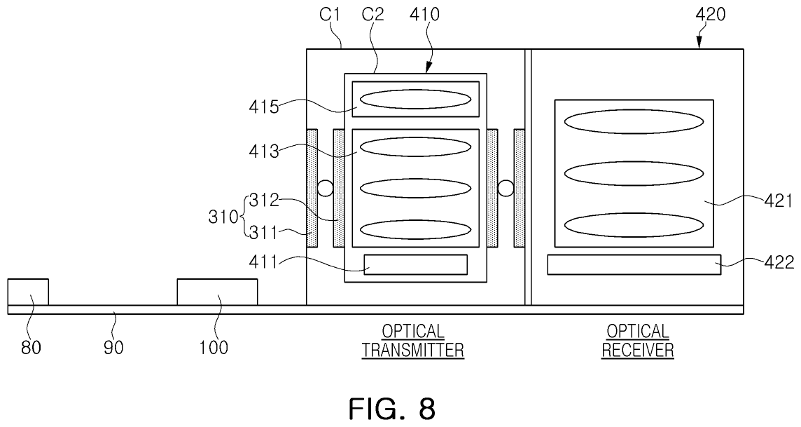

For example, the driving circuit 100 may output a first control signal SC1 and a second control signal SC2, control a light source 411 (FIG. 8) using the first control signal SC1, and control the actuator 300 using the second control signal SC2.

In addition, the driving circuit 100 may receive a sensing signal SD from the optical sensor 422 (FIG. 7) of the optical receiver 420 and recognize the subject based on the sensing signal SD.

The camera device of this application using the TOF function may overcome a limitation on a measurement distance caused by an external environment (light) in terms of characteristics of the technology, enable 3D scanning using transmission light including pattern light such as dots or other shapes in spite of a limitation in power that may be used in relation to eye safety when the optical transmitter uses a laser as a light source, improve a resolution by adjusting either one or both of an optical scanning direction and an FOL, and improve a measurement distance. This will be specifically described below.

In describing the drawings, redundant descriptions for the same reference numerals and components having the same function may be omitted, and only differences may be described for each drawing.

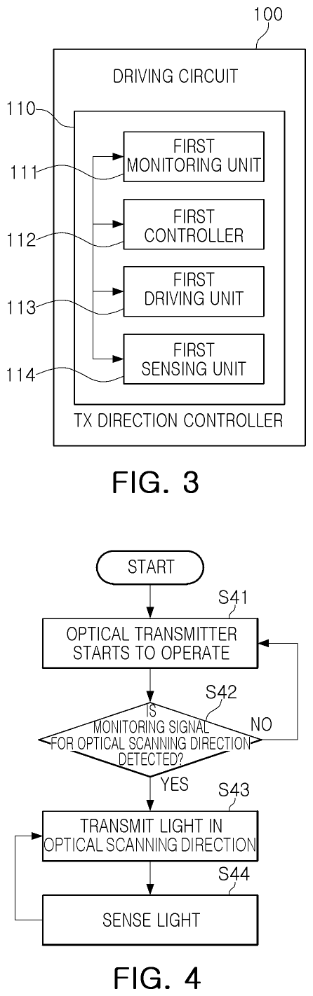

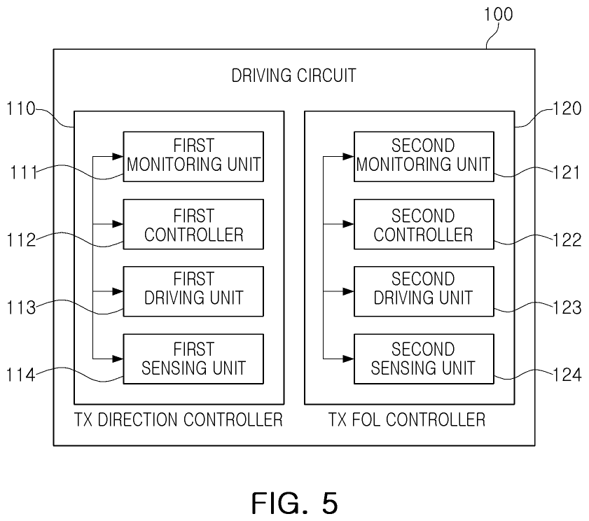

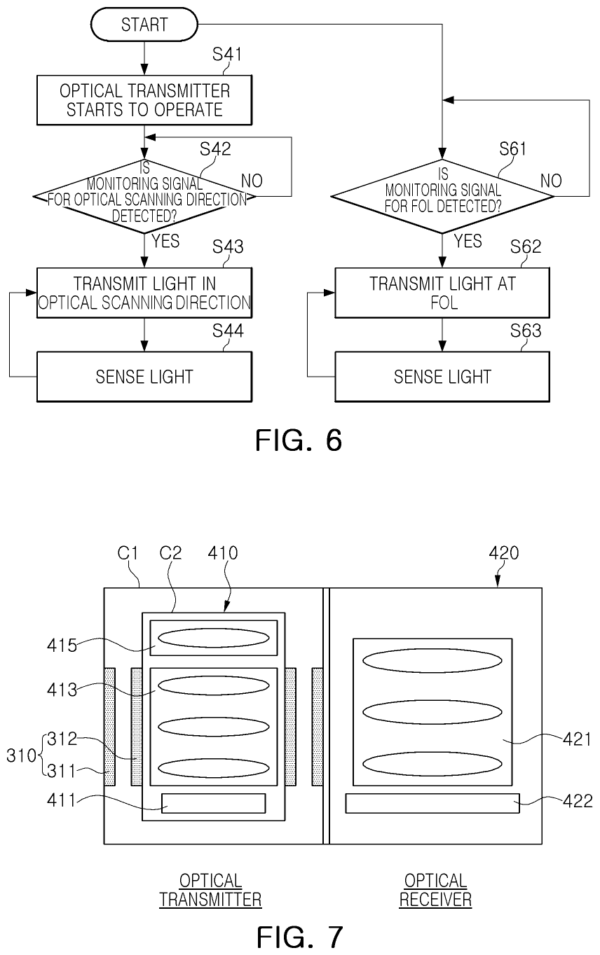

FIG. 3 is a view of an example of the driving circuit of FIG. 2, FIG. 4 is a view illustrating an operation of the driving circuit of FIG. 3, FIG. 5 is a view of another example of the driving circuit of FIG. 2, and FIG. 6 is a view illustrating an operation of the driving circuit of FIG. 5.

Referring to FIG. 3, the driving circuit 100 may include a transmit (TX) direction controller 110.

Referring to FIG. 5, the driving circuit 100 may include a TX direction controller 110 and a TX FOL controller 120.

Referring to FIGS. 3 and 5, the TX direction controller 110 may control an optical scanning direction of the optical transmitter 410.

For example, the TX direction controller 110 may include a first monitoring unit 111, a first controller 112, a first driving unit 113, and a first sensing unit 114.

The first monitoring unit 111 may select a measurement area and monitor a target position of the subject 1. For example, the first monitoring unit 111 may detect a monitoring signal including target position information and output the target position included in the monitoring signal to the first controller 112. For example, the target position may be determined according to a user selection.

The first controller 112 may calculate a target moving distance and a target movement direction based on a current position and the target position of the subject 1.

The first driving unit 113 may generate a first driving current and output the generated first driving current to the actuator 300 under the control of the first controller 112.

In addition, the first sensing unit 114 may sense the current position of the optical transmitter 410 and output the sensed current position to the first controller 112.

Referring to FIG. 4, an operation of transmitting and receiving light at a fixed FOL is described. First, the optical transmitter 410 starts to operate (S41), and when a monitoring signal for an optical scanning direction is detected (S42), the optical transmitter 410 transmits light in the optical scanning direction included in the monitoring signal (S43), and the light transmitted from the optical transmitter 410 may be reflected from the subject 1 and sensed by the optical receiver 420 (S44).

The monitoring signal may include target position information.

Referring to FIG. 5, the TX FOL controller 120 may adjust an FOL of the optical transmitter 410.

For example, the TX FOL controller 120 may include a second monitoring unit 121, a second controller 122, a second driving unit 123, and a second sensing unit 124.

The second monitoring unit 121 may monitor a target angle of the subject 1 using a user selection of a measurement area or an automatic selection of a measurement area.

The second controller 122 may calculate a target moving distance and a target movement direction based on a current FOL of the optical transmitter 410 and the target angle of the subject 1.

The second driving unit 123 may generate a second driving current and output the generated second driving current to the actuator 300 under the control of the second controller 122.

The second sensing unit 124 may sense the current FOL of the optical transmitter 410 and output the sensed current FOL to the second controller 122.

Referring to FIG. 6, an operation of transmitting and receiving light at a fixed narrow FOL is described. First, the optical transmitter 410 starts to operate (S41), and when a monitoring signal for an optical scanning direction is detected (S42), the optical transmitter 410 transmits light in the optical scanning direction included in the monitoring signal (S43), and the light transmitted from the optical transmitter 410 may be reflected from the subject 1 and sensed by the optical receiver 420 (S44).

In addition, when a monitoring signal for an FOL is detected (S61), the optical transmitter 410 transmits light at the FOL included in the monitoring signal (S62), and the light transmitted from the optical transmitter 410 may be reflected from the subject 1 and sensed by the optical receiver 420 (S63).

FIG. 7 is a view of an example of an optical transmitter and an optical receiver, and FIG. 8 is a view of another example of an optical transmitter and an optical receiver.

Referring to FIGS. 7 and 8, for example, the optical transmitter 410 may include a light source 411, a TX lens unit 413, and a diffraction optical element (DOE) lens unit 415.

The light source 411 may generate light to be scanned to the subject 1.

The TX lens unit 413 may include a plurality of lenses and may focus the light from the light source 411.

The DOE lens unit 415 may convert the focused light from the TX lens unit 413 into DOE pattern light and scan the DOE pattern light to the subject 1.

For example, the optical receiver 420 may include a receive (RX) lens unit 421 and an optical sensor 422.

The RX lens unit 421 may include a plurality of lenses and focus light incident from the subject 1.

The optical sensor 422 may sense the focused light from the RX lens unit 421. For example, the optical sensor 422 may be a single photon avalanche diode (SPAD), a silicon photomultiplier (SiPM), or any other optical sensor capable of sensing the focused light from the RX lens unit.

Referring to FIGS. 7 and 8, the actuator 300 may include a first actuator 310 adjusting an optical scanning direction of the optical transmitter 410.

For example, the first actuator 310 may include a first driving coil 311 and a first magnet 312.

The first driving coil 311 may be disposed in an external case C1, be spaced apart from the optical transmitter 410, and generate a magnetic force according to a first driving current.

The first magnet 312 may be disposed in an internal case C2 of the optical transmitter 410, be disposed to face the first driving coil 311, and adjust an optical scanning direction of the optical transmitter 410 according to the magnetic force generated by the first driving coil 311.

Referring to FIG. 8, the driving circuit 100 may be mounted on a board 90 on which the optical transmitter 410 and the optical receiver 420 are mounted, and the board 90 may include a connector 80.

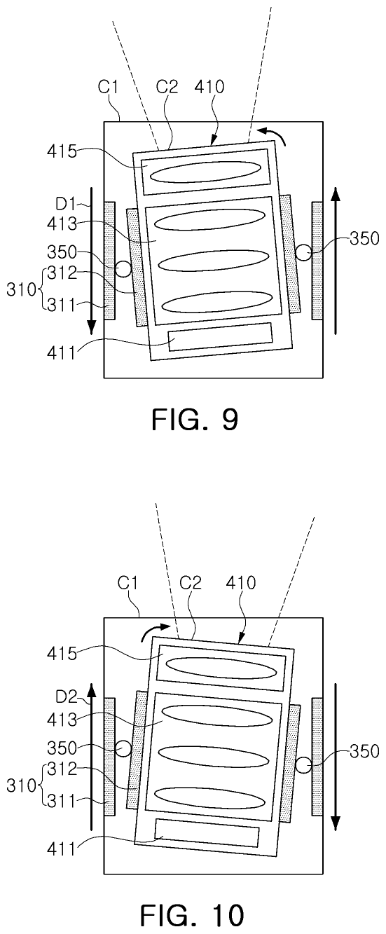

FIG. 9 is a view illustrating an example of adjustment of an optical scanning direction of the optical transmitter of FIG. 7, and FIG. 10 is a view illustrating another example of adjustment of the optical scanning direction of the optical transmitter of FIG. 7.

Referring to FIGS. 9 and 10, the first actuator 310 may include a guide ball 350.

The guide ball 350 may be moved according to a magnetic force between the first driving coil 311 and the first magnet 312 to adjust the optical scanning direction of the optical transmitter 410.

For example, in the optical transmitter 410, the optical scanning direction may be adjusted in a first direction D1 (see FIG. 9), or in a second direction D2 (see FIG. 10), or in a direction different from the first and second directions, according to a magnetic force acting between the first driving coil 311 and the first magnet 312.

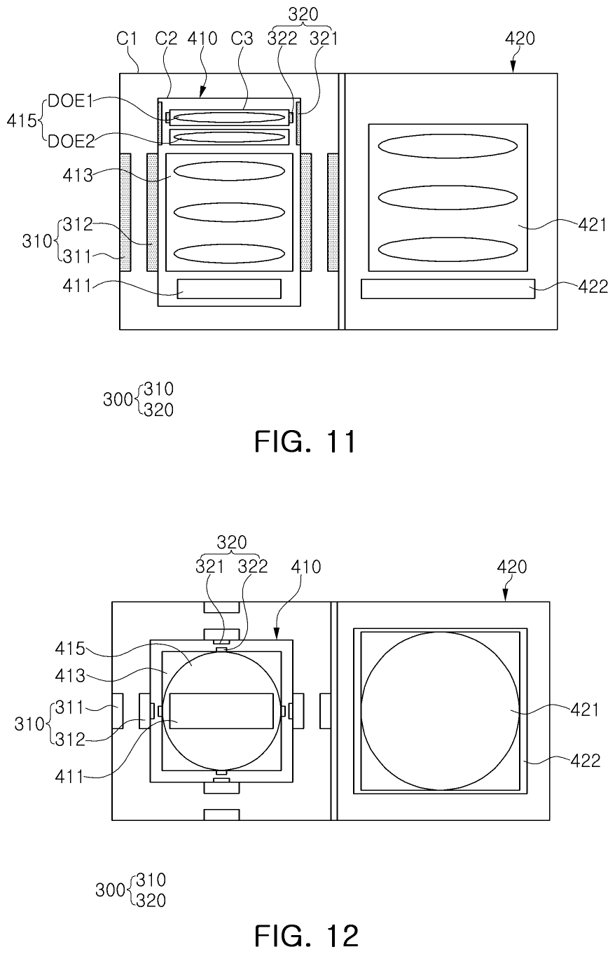

FIG. 11 is a side view of another example of an optical transmitter and an optical receiver, and FIG. 12 is a front view of the optical transmitter and the optical receiver of FIG. 11.

Referring to FIGS. 11 and 12, the actuator 300 may include a second actuator 320 adjusting an FOL of the optical transmitter 410.

For example, the second actuator 320 may include a second driving coil 321 and a second magnet 322.

The second driving coil 321 may be disposed inside the internal case C1 of the optical transmitter 410, be spaced apart from the DOE lens unit 415, and generate a magnetic force according to a second driving current.

The second magnet 322 may be disposed to face the second driving coil 321 in a case C3 of the DOE lens unit 415 and adjust a position of one of the first and second DOE lenses DOE1 and DOE2 included in the DOE lens unit 415 according to the magnetic force generated by the second driving coil 321.

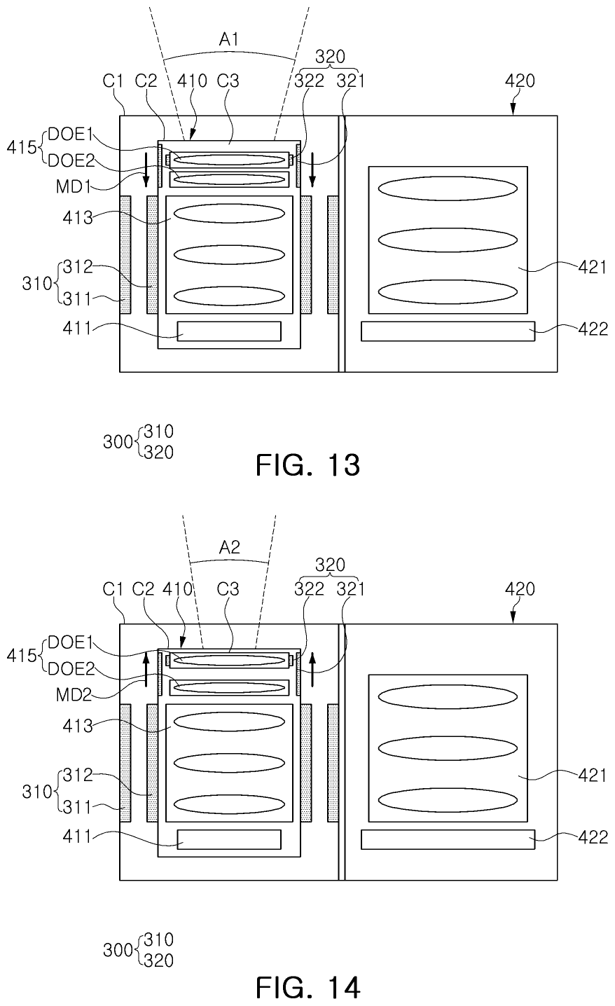

FIG. 13 is a view illustrating an example of adjustment of an FOL of the optical transmitter of FIG. 11, and FIG. 14 is a view illustrating another example of adjustment of the FOL of the optical transmitter of FIG. 11.

Referring to FIGS. 13 and 14, the DOE lens unit 415 may include a first DOE lens DOE1 and a second DOE lens DOE2.

The first DOE lens DOE1 may be disposed to be perpendicular to an optical axis. The second DOE lens DOE2 may be disposed to be perpendicular to the optical axis and be spaced apart from the DOE lens DOE1 by a predetermined distance. One of the first DOE lens DOE1 and the second DOE lens DOE2 may be disposed to be movable in order to adjust the FOL.

For example, the FOL of the optical transmitter 410 may be adjusted by adjusting a position of the first DOE lens DOE1 among the first and second DOE lenses DOE1 and DOE2. For example, the optical transmitter 410 may be adjusted to a first FOL A1 (see FIG. 13), or a second FOL A2 (see FIG. 14), or an FOL different from the first FOL and the second FOL, according to a first position movement direction MD1 of the first DOE lens DOE1 or a second position movement direction MD2 of the first DOE lens DOE1.

For example, the first position movement direction MD1 of the first DOE lens DOE1 may be a direction in which the first DOE lens DOE1 moves so that the first and second DOE lenses DOE1 and DOE2 become closer to each other. Also, the second position movement direction MD2 of the first DOE lens DOE1 may be a direction in which the first DOE lens DOE1 moves so that the first and second DOE lenses DOE1 and DOE2 move away from each other.

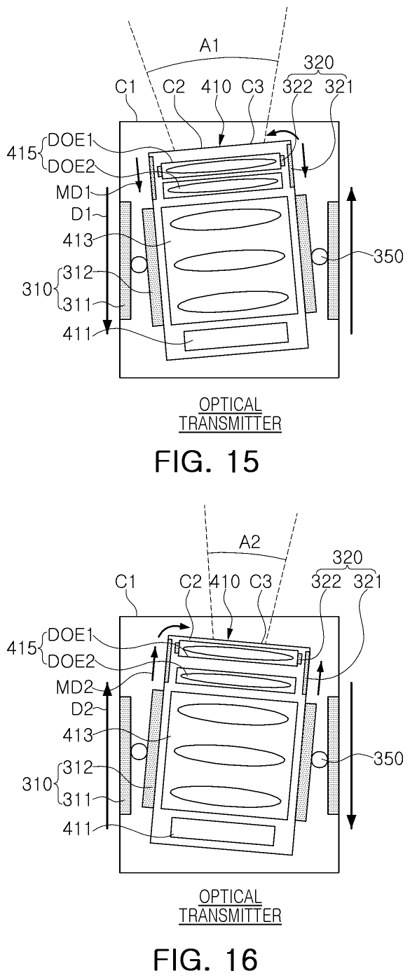

FIG. 15 is a view illustrating an example of adjustment of an optical scanning direction and an FOL of the optical transmitter of FIG. 11, and FIG. 16 is a view illustrating another example of adjustment of the optical scanning direction and the FOL of the optical transmitter of FIG. 11.

Referring to FIG. 15, in the optical transmitter 410, the optical scanning direction may be adjusted in the first direction D1 by the first actuator 310, and the first DOE lens DOE1 may be moved in the first movement direction MD1 by the second actuator 320 so that the optical transmitter 410 may be adjusted to the first FOL A1.

Referring to FIG. 16, in the optical transmitter 410, the optical scanning direction may be adjusted in the second direction D2 by the first actuator 310, and the first DOE lens DOE1 may be moved in the second movement direction MD2 by the second actuator 320 so that the optical transmitter 410 may be adjusted to the second FOL A2.

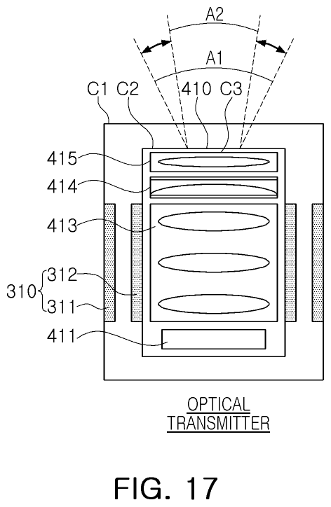

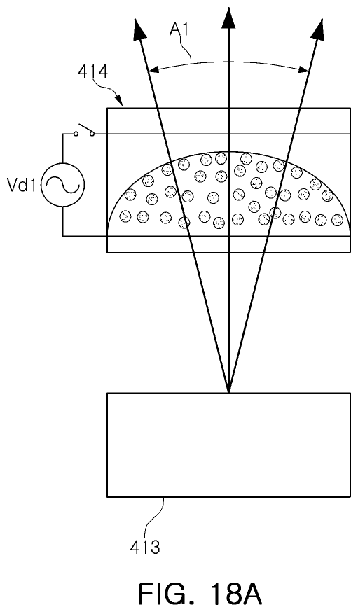

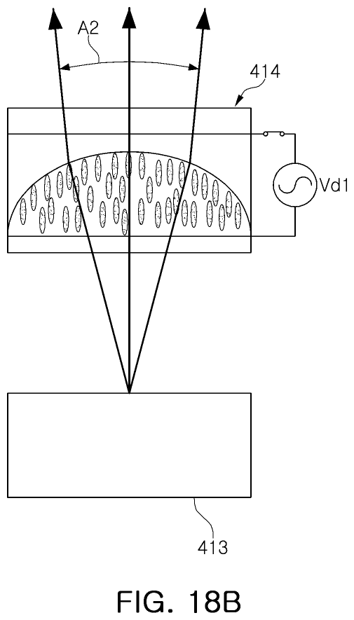

FIG. 17 is a view of another example of an optical transmitter, and FIGS. 18A and 18B are views illustrating examples of an operation of a liquid crystal lens unit of the optical transmitter of FIG. 17.

Referring to FIG. 17, the optical transmitter 410 may include a liquid crystal lens unit 414.

For example, the liquid crystal lens unit 414 may be disposed between the TX lens unit 413 and the DOE lens unit 415, and may adjust an FOL in response to a voltage controlled by the driving circuit 100.

Referring to FIGS. 18A and 18B, when a first driving voltage Vd1 is not supplied to the liquid crystal lens unit 414, the FOL may be adjusted to be a wide FOL A1 (see FIG. 18A), and when the first driving voltage Vd1 is supplied to the liquid crystal lens unit 414, the FOL may be adjusted to be a narrow FOL A2 (see FIG. 18B).

The first driving voltage Vd1 may be a voltage controlled under the control of the driving circuit 100.

The TOF camera device as described above may adjust the optical scanning direction and the FOL, thereby improving a maximum measurement distance and a resolution, which is described with reference to the accompanying drawings.

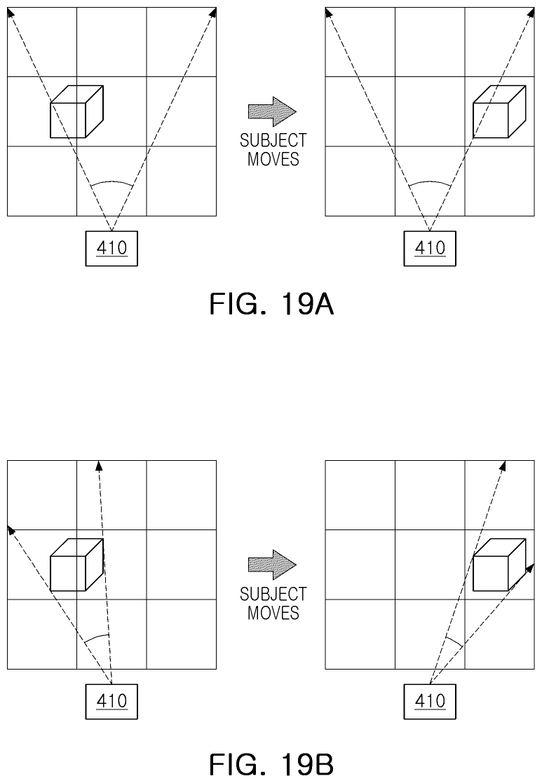

FIGS. 19A and 19B are views of examples of optical scanning according to whether or not a subject is tracked.

FIG. 19A is a view illustrating an example of optical scanning without using a subject 1 tracking function, and FIG. 19B is a view illustrating another example of optical scanning using the subject 1 tracking function.

Referring to FIG. 19A, in the existing camera device, even when the subject 1 moves, optical scanning is performed uniformly at a wide FOL. In contrast, referring to FIG. 19B, in the camera device of this application, when the subject 1 moves, the subject is tracked and light may be scanned toward the subject 1 at a narrow FOL with a high resolution.

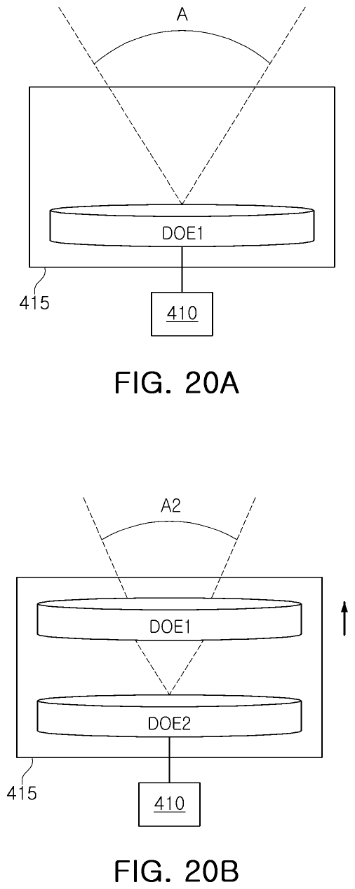

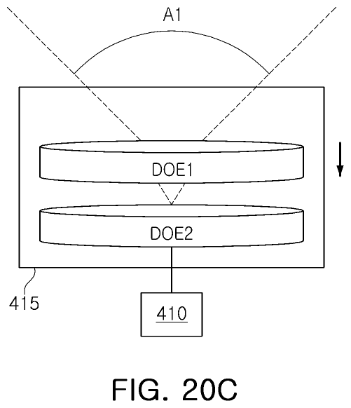

FIGS. 20A, 20B, and 20C are views illustrating examples of adjustment of an FOL using a DOE lens.

Referring to FIG. 20A, when the DOE lens unit 415 includes a single DOE lens, an FOL A may be fixed.

Referring to FIGS. 20B and 20C, when the DOE lens unit 415 includes the first and second DOE lenses DOE1 and DOE2, the FOL may be adjusted to be a narrow FOL A2 (see FIG. 20B), or a wide FOL A1 (see FIG. 20C), by moving a position of the first DOE lens DOE1.

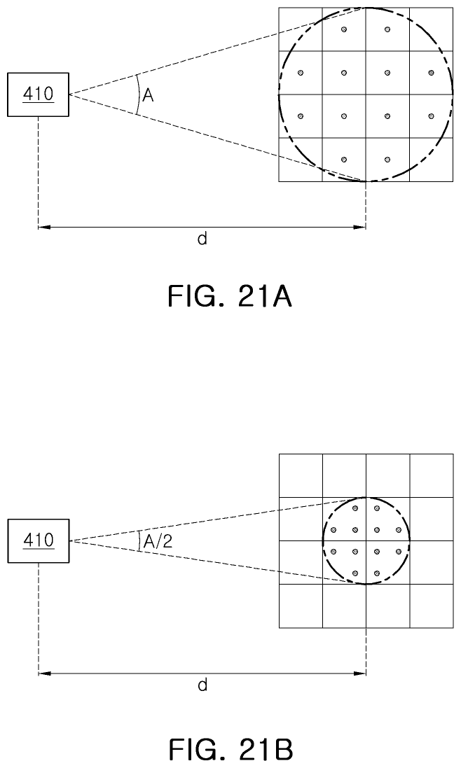

FIGS. 21A and 21B are views illustrating examples of a change in a resolution according to adjustment of an FOL.

FIGS. 21A and 21B illustrate that a resolution may be improved by adjusting the FOL for the same maximum measurement distance d.

For example, when an FOL A in FIG. 21A is changed to an FOL A/2 in FIG. 21B, in a case in which laser light having a 12-dot pattern in the FOL is scanned, if the FOL is narrowed, the laser light having the 12-dot pattern becomes more dense in the narrow scanning area, thereby increasing a resolution accordingly.

In the following description, examples in which the laser light includes a 12-dot pattern are described, but this is only for convenience of description, and the laser light may include other types of patterns.

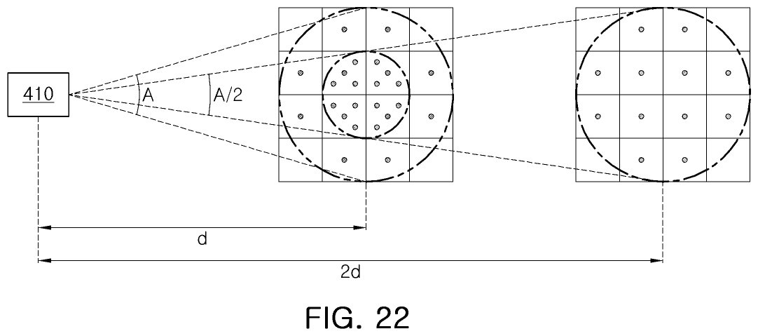

FIG. 22 is a view illustrating a measurement distance according to adjustment of an FOL.

Referring to FIG. 22, comparing to a case of the wide FOL A and the case of a narrow FOL A/2 for laser light having the same power, a resolution is higher when the FOL is small at the same maximum measurement distance d, referring to the 12-dot patterns included in the optical scanning region.

In addition, a maximum measurement distance 2d for the narrow FOL A/2 is longer than a maximum measurement distance d for the wide FOL A, and the resolutions are similar to each other. That is, it can be seen that the maximum measurement distance may be increased when the FOL is reduced, and when the FOL is reduced, intensity of the laser light may be increased at the same maximum measurement distance d.

In other words, in the existing camera device, when transmission power of the optical transmitter is the same, an arrival intensity at a target point is weaker as the FOL increases. In the camera device of this application, it is possible to measure farther by reducing the FOL, and at the same time, an insufficient sensing region due to the decrease in the FOL may be compensated by controlling the optical scanning direction of the optical transmitter using the actuator.

In addition, like controlling autofocusing (AF) of a folded camera module, the optical transmitter includes two DOE lenses and a final FOL may be adjusted by controlling one of the DOE lenses. When the FOL is adjusted in this manner, the maximum measurement distance may be changed, and accordingly, subjects at a longer distance may be measured.

In addition, the resolution may be improved by transmitting laser at a narrow FOL while following the subject based on the position of the subject, instead of the optical transmitter transmitting light at the full FOL.

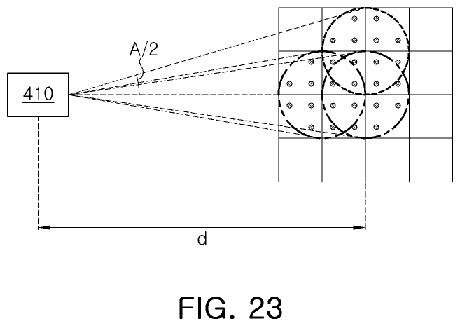

FIG. 23 is a view illustrating an example of improvement of a resolution according to adjustment of an FOL and an optical scanning direction.

Referring to FIG. 23, when the wide FOL A is reduced to the narrow FOL A/2, the optical scanning region may be compensated and a high resolution may be maintained by adjusting the optical scanning direction using an actuator.

Such an optical scanning direction may be adjusted by, for example, an actuator employing a guide ball structure, or a laser light transmission direction may be adjusted using a liquid crystal lens unit without using a separate actuator.

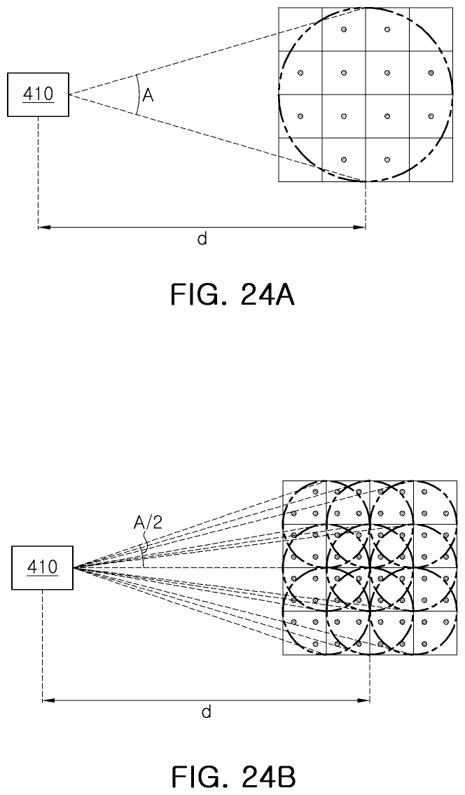

FIGS. 24A and 24B are views illustrating other examples of improvement of a resolution according to adjustment of an FOL and an optical scanning direction.

Referring to FIG. 24A, in a case in which a 12-dot pattern laser light having a FOL A and a maximum measurement distance d is scanned to a subject, a resolution of the laser light for the subject at the maximum measurement distance d is shown.

In the case of using laser light of power as shown in FIG. 24B, if the FOL is reduced, a higher resolution may be obtained at the same maximum measurement distance d, and in this case, the intensity of laser light at the same maximum measurement distance d may also become strong.

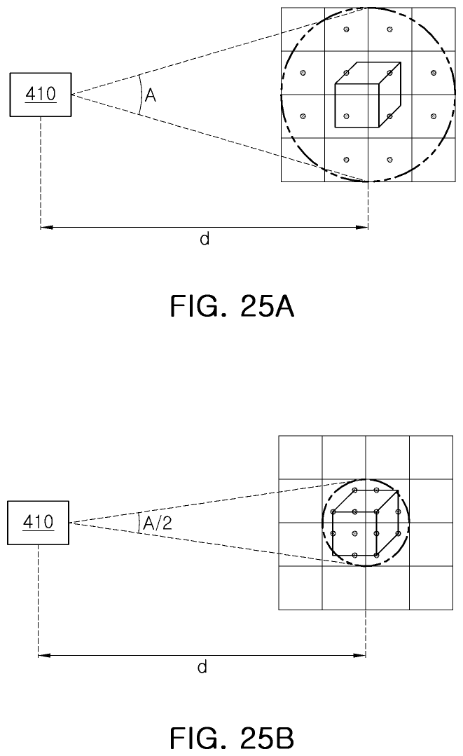

FIGS. 25A and 25B are views illustrating other examples of improvement of a resolution according to adjustment of an FOL.

Referring to FIG. 25A, in a case in which a laser light having a 12-dot pattern having a fixed FOL A and a maximum measurement distance d is scanned to a subject, it is assumed that a level of a resolution matching the stationary subject (cube) includes laser light having four dots.

When laser light having power as shown in FIG. 25B is used, a level of a resolution matching the stationary object (cube) may be a level including laser light having about 12 dots, and it can be seen that the resolution is higher than the resolution of FIG. 25A in terms of an optical signal received by the optical receiver.

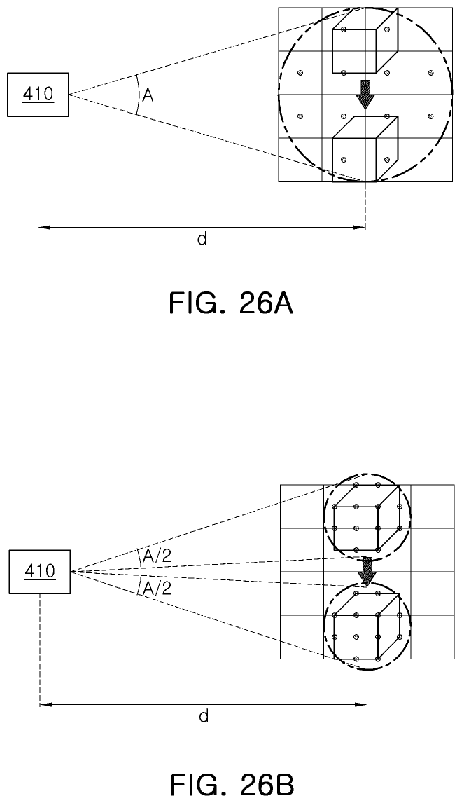

FIGS. 26A and 26B are views illustrating other examples of improvement of a resolution according to adjustment of an FOL and an optical scanning direction.

Referring to FIG. 26A, in a case in which laser light having a 12-dot pattern is scanned to a subject having a fixed FOL A and a maximum measurement distance d of the optical transmitter, it is assumed that a level of a resolution matching a moving subject (cube) includes laser light having 2 to 4 dots.

When the optical transmitter having power as shown in FIG. 26B follows the subject, a level of a resolution matching the moving subject (cube) may be a level including laser light having about 12 dots, and it can be seen that the resolution is higher than the resolution of FIG. 26A in terms of an optical signal received by the optical receiver.

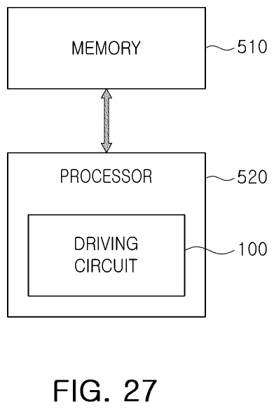

FIG. 27 is a block diagram illustrating an example of the driving circuit of FIGS. 2, 3, 5, and 8.

Referring to FIG. 27, a memory 510 stores instructions that, when executed by a processor 520, cause the processor 520 to perform the functions of the driving circuit 100 of FIGS. 2, 3, 5, and 8. Thus, the processor 520 includes the control circuit 100.

As described above, as the actuator of the TOF camera device of this application, actuators having a voice coil motor (VCM) structure (i.e., the first actuator 310 and the second actuator 320) may be employed. Alternatively, actuators having a micro-electromechanical system (MEMS) structure may be employed.

In addition, it is possible to follow a subject using a liquid crystal lens, instead of a separate actuator.

The camera device of this application as described above may be applied to all applications using to TOF camera module, such as intelligent driving devices, robots, smart homes, smart TVs, smart security, VR, AR, gaming, and car displays, in addition to smartphones.

The driving circuit 100 of FIGS. 2, 3, 5, and 8 may be implemented in a computing environment in which a processor (e.g., a central processing unit (CPU), a graphics processing unit (GPU), a microprocessor, an application-specific integrated circuit (ASIC), a field-programmable gate array (FPGA), etc.), a memory (e.g., volatile memory (e.g., random-access memory (RAM), etc.), non-volatile memory (e.g., read-only memory (ROM), flash memory, etc.), an input device (e.g., a keyboard, a mouse, a pen, a voice input device, a touch input device, an infrared camera, a video input device, etc.), an output device (e.g., a display, a speaker, a printer, etc.), and a communication connection device (e.g., a modem, a network interface card (NIC), an integrated network interface, a radio-frequency (RF) transmitter/receiver, an infrared port, a USB connection device, etc.) are interconnected.

The driving circuit 100 in FIGS. 2, 3, 5, and 8, the TX direction controller 110, the first monitoring unit 111, the first controller 112, the first driving unit 113, and the first sensing unit 114 in FIGS. 3 and 5, and the TX FOL controller 120, the second monitoring unit 121, the second controller 122, the second driving unit 123, and the second sensing unit 124 in FIG. 5 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 4 and 6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

As set forth above, according to in the examples of the TOF camera device described above, either one or both of an optical scanning direction and an FOL may be adjusted based on a position of a subject, and accordingly, a maximum measurement distance and a resolution of 3D sensing for the subject may be improved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A time-of-flight (TOF) camera device comprising:
an optical transmitter configured to transmit light to a subject;
an optical receiver configured to receive light reflected from the subject; and
an actuator configured to adjust either one or both of an optical scanning direction and a field of luminance (FOL) of the optical transmitter.

2. The TOF camera device of claim 1, wherein the actuator comprises a first actuator configured to adjust an optical scanning direction of the optical transmitter, and
the first actuator comprises:
a first driving coil disposed in an external case and spaced apart from the optical transmitter, and configured to generate a magnetic force according to a first driving current; and
a first magnet disposed in an internal case of the optical transmitter and facing the first driving coil, and configured to adjust the optical scanning direction of the optical transmitter according to the magnetic force generated by the first driving coil.

3. The TOF camera device of claim 2, wherein the first actuator further comprises a guide ball configured to move according to a magnetic force between the first driving coil and the first magnet to adjust the optical scanning direction of the optical transmitter.

4. The TOF camera device of claim 1, wherein the optical transmitter comprises:
a light source configured to generate light to be scanned to the subject;
a transmit (TX) lens unit comprising a plurality of lenses configured to focus the light from the light source; and
a diffraction optical element (DOE) lens unit configured to convert the focused light from the TX lens unit into DOE pattern light and scan the DOE pattern light to the subject.

5. The TOF camera device of claim 4, wherein the DOE lens unit comprises:
a first DOE lens disposed to be perpendicular to an optical axis; and
a second DOE lens disposed to be spaced apart from the first DOE lens by a predetermined distance and perpendicular to the optical axis,
wherein one of the first DOE lens and the second DOE lens is configured to be movable to adjust the FOL of the optical transmitter.

6. The TOF camera device of claim 5, wherein the actuator comprises a second actuator configured to adjust the FOL of the optical transmitter, and
the second actuator comprises:
a second driving coil disposed inside an internal case of the optical transmitter and spaced apart from the DOE lens unit, and configured to generate a magnetic force according to a second driving current; and
a second magnet disposed in a case of the DOE lens unit and facing the second driving coil, and configured to adjust a position of the one of the first DOE lens and the second DOE lens that is configured to be movable according to the magnetic force generated by the second driving coil.

7. The TOF camera device of claim 4, wherein the optical transmitter further comprises a liquid crystal lens unit disposed between the TX lens unit and the DOE lens unit, and configured to adjust the FOL of the optical transmitter in response to a voltage.

8. The TOF camera device of claim 1, wherein the optical receiver comprises:
a receive (RX) lens unit configured to focus light incident on the RX lens unit from the subject; and
an optical sensor configured to sense the focused light from the RX lens unit.

9. A time-of-flight (TOF) camera device comprising:
an optical transmitter configured to transmit light to a subject;
an optical receiver configured to receive light reflected from the subject;
an actuator configured to adjust either one or both of an optical scanning direction and a field of luminance (FOL) of the optical transmitter; and
a driving circuit configured to adjust the optical transmitter by controlling the actuator based on a position of the subject.

10. The TOF camera device of claim 9, wherein the driving circuit comprises a transmit (TX) direction controller configured to control the optical scanning direction of the optical transmitter.

11. The TOF camera device of claim 10, wherein the TX direction controller comprises:
a first monitoring unit configured to select a measurement region and monitor a target position of the subject;
a first controller configured to calculate a target movement distance and a target movement direction based on a current position of the subject and the target position of the subject;
a first driving unit configured to generate a first driving current and output the generated first driving current to the actuator under control of the first controller; and
a first sensing unit configured to sense the current position of the optical transmitter.

12. The TOF camera device of claim 11, wherein the driving circuit further comprises a TX angle of view (FOL) controller configured to adjust the FOL of the optical transmitter.

13. The TOF camera device of claim 12, wherein the TX FOL controller comprises:
a second monitoring unit configured to monitor a target angle of the subject using user selection of a measurement region or automatic selection of a measurement region;
a second controller configured to calculate a target movement distance and a target movement direction based on a current FOL of the optical transmitter and the target angle of the subject;
a second driving unit configured to generate a second driving current and output the generated second driving current to the actuator under control of the second controller; and
a second sensing unit configured to sense the current FOL of the optical transmitter.

14. The TOF camera device of claim 9, wherein the actuator comprises a first actuator configured to adjust the optical scanning direction of the optical transmitter, and
the first actuator comprises:
a first driving coil disposed in an external case and spaced apart from the optical transmitter, and configured to generate a magnetic force according to a first driving current; and
a first magnet disposed in an internal case of the optical transmitter and facing the first driving coil, and configured to adjust the optical scanning direction of the optical transmitter according to the magnetic force generated by the first driving coil.

15. The TOF camera device of claim 14, wherein the first actuator further comprises a guide ball configured to move according to a magnetic force between the first driving coil and the first magnet to adjust the optical scanning direction of the optical transmitter.

16. The TOF camera device of claim 9, wherein the optical transmitter comprises:
a light source configured to generate light to be scanned to the subject;
a transmit (TX) lens unit comprising a plurality of lenses configured to focus the light from the light source; and
a diffraction optical element (DOE) lens unit configured to convert the focused light from the TX lens unit into DOE pattern light and scan the DOE pattern light to the subject.

17. The TOF camera device of claim 16, wherein the DOE lens unit comprises:
a first DOE lens disposed to be perpendicular to an optical axis; and
a second DOE lens disposed to be spaced apart from the DOE lens by a predetermined distance and perpendicular to the optical axis,
wherein one of the first DOE lens and the second DOE lens is configured to be movable to adjust the FOL of the optical transmitter.

18. The TOF camera device of claim 17, wherein the actuator further comprises a second actuator configured to adjust the FOL of the optical transmitter, and
the second actuator comprises:
a second driving coil disposed inside an internal case of the optical transmitter spaced apart from the DOE lens unit and configured to generate a magnetic force according to a second driving current; and
a second magnet disposed in a case of the DOE lens unit, facing the second driving coil, and configured to adjust a position of the first DOE lens or the second DOE lens included in the DOE lens unit according to the magnetic force generated by the second driving coil.

19. The TOF camera device of claim 16, wherein the optical transmitter further comprises a liquid crystal lens unit disposed between the TX lens unit and the DOE lens unit and configured to adjust the FOL of the optical transmitter in response to a voltage under control of the driving circuit.

20. The TOF camera device of claim 9, wherein the optical receiver comprises:
a receive (RX) lens unit configured to focus light incident on the RX lens unit from the subject; and
an optical sensor configured to sense the focused light from the RX lens unit.

21. A time-of-flight (TOF) camera device comprising:
an optical transmitter configured to transmit light to a subject;
an optical receiver configured to receive light reflected from the subject; and
an actuator configured to adjust either one or both of a position of a measurement area and a resolution of the TOF camera.

22. The TOF camera of claim 21, wherein the actuator is further configured to adjust the position of the measurement area by adjusting an optical scanning direction of the optical transmitter.

23. The TOF camera of claim 22, wherein the actuator comprises a first actuator configured to adjust the optical scanning direction of the optical transmitter, and
the first actuator comprises:
a first driving coil disposed in an external case and spaced apart from the optical transmitter, and configured to generate a magnetic force according to a first driving current; and
a first magnet disposed in an internal case of the optical transmitter and facing the first driving coil, and configured to adjust the optical scanning direction of the optical transmitter according to the magnetic force generated by the first driving coil.

24. The TOF camera of claim 21, wherein the actuator is further configured to adjust the resolution by adjusting a field of luminance (FOL) of the optical transmitter.

25. The TOF camera device of claim 24, wherein the optical transmitter comprises:
a light source configured to generate light to be scanned to the subject;
a transmit (TX) lens unit comprising a plurality of lenses configured to focus the light from the light source; and
a diffraction optical element (DOE) lens unit configured to convert the focused light from the TX lens unit into DOE pattern light and scan the DOE pattern light to the subject.

26. The TOF camera device of claim 25, wherein the DOE lens unit comprises:
a first DOE lens disposed to be perpendicular to an optical axis; and
a second DOE lens disposed to be spaced apart from the first DOE lens by a predetermined distance and perpendicular to the optical axis,
wherein one of the first DOE lens and the second DOE lens is configured to be movable to adjust the FOL of the optical transmitter.

27. The TOF camera device of claim 26, wherein the actuator comprises a second actuator configured to adjust the FOL of the optical transmitter, and
the second actuator comprises:
a second driving coil disposed inside an internal case of the optical transmitter and spaced apart from the DOE lens unit, and configured to generate a magnetic force according to a second driving current; and
a second magnet disposed in a case of the DOE lens unit and facing the second driving coil, and configured to adjust a position of the one of the first DOE lens and the second DOE lens that is configured to be movable according to the magnetic force generated by the second driving coil.

28. The TOF camera device of claim 25, wherein the optical transmitter further comprises a liquid crystal lens unit disposed between the TX lens unit and the DOE lens unit, and configured to adjust the FOL of the optical transmitter in response to a voltage.
